(19) United States
(12) Patent Application Publication
(10) Pub. No.: US 2002/0098398 A1
(43) Pub. Date: Jul. 25, 2002

(54) Electrolyte balance in electrochemical cells

(76) Inventor: Muguo Chen, Bedford Hills, NY (US)

Correspondence Address: RALPH J. CRISPINO, REVEO, INC., 85 EXECUTIVE BLVD., ELMSFORD, NY, 10523, US

(21) Appl. No.: 10/055,845

(22) Filed: Jan. 22, 2002

Related U.S. Application Data
(60) Provisional application No. 60/263,174, filed on Jan. 22, 2001.

(51) Int. Cl. H01M 12/06; H01M 8/24; H01M 10/30; H01M 2/14

(52) U.S. Cl. 429/18; 429/27; 429/129

(57) ABSTRACT

A rechargeable metal air electrochemical cell is provided. The rechargeable metal air electrochemical cell generally includes an anode and a cathode in ionic communication via a separator and in fluid communication via one or more tubes or apertures, wherein the one or more tubes or apertures provide sufficient ionic resistance thereby preventing shorting between the electrodes while allowing liquid solvent to flow therebetween.

### RELATED APPLICATIONS

The present application claims priority to U.S. Provisional Patent Application Serial No. 60/263,174 entitled “Electrolyte Balance Device” filed on Jan. 22, 2001 by Muguo Chen, the entire disclosure of which is incorporated herein by reference in its entirety.

### BACKGROUND OF THE INVENTION

1. Field of the Invention

The present invention relates to electrochemical cells. More particularly, the invention relates to electrolyte balance in electrochemical cells.

2. Description of the Prior Art

Electrochemical power sources are devices through which electric energy can be produced by means of electrochemical reactions. These devices include metal air electrochemical cells such as zinc air and aluminum air batteries. Such metal air electrochemical cells employ an anode comprised of metal that is converted to a metal oxide during discharge. Certain electrochemical cells are, for example, rechargeable, whereby a current may be passed through the anode to reconvert metal oxide into metal for later discharge. Additionally, refuelable metal air electrochemical cells are configured such that the anode material may be replaced for continued discharge. Generally, metal air electrochemical cells include an anode, a cathode, and electrolyte. The anode is generally formed of metal particles immersed in electrolyte. The cathode generally comprises a bi-functional semipermeable membrane and a catalyzed layer for reducing oxygen. The electrolyte is usually a caustic liquid that is ionic conducting but not electrically conducting.

Metal air electrochemical cells have numerous advantages over traditional hydrogen-based fuel cells. In particular, the supply of energy provided from metal air electrochemical cells is virtually inexhaustible because the fuel, such as zinc, is plentiful and can exist either as the metal or its oxide. Further, solar, hydroelectric, or other forms of energy can be used to convert the metal from its oxide product back to the metallic fuel form with very high energy efficiency. Unlike conventional hydrogen based fuel cells that require refilling, the fuel of metal air electrochemical cells is recoverable by electrically recharging. The fuel of the metal air electrochemical cells may be solid state, therefore, it is safe and easy to handle and store. In contrast to hydrogen based fuel cells, which use methane, natural gas, or liquefied natural gas to provide as source of hydrogen, and emit polluting gases, the metal air electrochemical cells results in zero emission. The metal air fuel cell batteries operate at ambient temperature, whereas hydrogen-oxygen fuel cells typically operate at temperatures in the range of 150° C. to 1000° C. Metal air electrochemical cells are capable of delivering higher output voltages (1-4.5 Volts) than conventional fuel cells (<0.8V).

FIG. 1 shows a conventional metal air cell 100, including an anode 112, a cathode 114 and a separator 116. The cell is immersed in an electrolyte bath 118 contained in a housing 120, or otherwise contains electrolyte (e.g., through suitable framing structures).

Oxygen from the air or another source is used as the reactant for the air cathode 114 of the metal air cell 100. When oxygen reaches the reaction sites within the cathode 114, it is converted into hydroxyl ions together with water. At the same time, electrons are released to flow as electricity in the external circuit. The hydroxyl travels through the separator 116 to reach the metal anode 112. When hydroxyl reaches the metal anode (in the case of an anode 112 comprising, for example, zinc), zinc hydroxide is formed on the surface of the zinc. Zinc hydroxide decomposes to zinc oxide and releases water back to the alkaline solution. The reaction is thus completed.

The anode reaction is:

Zn+40H⁻→Zn(OH)₄²⁻⁺2e (1)

Zn(OH)₄²⁻→ZnO+H₂O+2OH⁻ (2)

The cathode reaction is:

½O₂+H₂O+2e→2OH⁻ (3)

Thus, the overall cell reaction is:

Zn+½O₂→ZNO (4)

In a rechargeable cell, the cathode 114 may be a bifunctional electrode, for example, or a third electrode 215 may be employed, as shown in FIG. 2, with a separator 216 between electrode 215 and an anode 212, and a separator 217 between electrode 215 and a cathode 214. In either case (e.g., bi-functional electrode 114 or including a third electrode 215), during recharging, consumed anode material (i.e., oxidized metal), which is in ionic contact with the bi-functional electrode 114 or third electrode 215, is converted into fresh anode material (i.e., metal) and oxygen upon application of a power source (e.g. more than 2 volts for metal-air systems) across the bi-functional electrode 1 14 or third electrode 215 and consumed anode material. The current flows in through bi-functional electrode 114 or third electrode 215 and converts the anode metal oxide to metal releasing the oxygen.

Other pertinent electrochemical cells may have the bifunctional electrode configuration depicted in FIG. 1. For example, anode 112 is zinc or zinc oxide, and cathode 114 is nickel oxide, manganese dioxide, silver oxide, or cobalt oxide. Alternatively, anode 112 may be iron or cadmium, and single bifunctional electrode 114 is nickel oxide. In these systems, the ionic species preferably is aqueous alkaline hydroxide solution and associated hydroxide concentration; however, the ionic species may also come from a neutral aqueous solution.

In either discharging or recharging (although more so in recharging), not only are the ions within the electrolyte involved in electrochemical reaction, but the solvent also plays a role. At relatively low reaction rates, transport of the solvent between electrodes is not a consideration. However, at higher rates of discharge, transport of solvent is preferred, which becomes particularly problematic when a separator is chosen that is conductive to ions but not permeable to solvents.

There remains a need in the art for an improved rechargeable electrochemical cell, particularly regarding a cathode assembly for an electrochemical cell.

### SUMMARY OF THE INVENTION

The above-discussed and other problems and deficiencies of the prior art are overcome or alleviated by the several methods and apparatus of the present invention, wherein a rechargeable metal air electrochemical cell is provided. The rechargeable metal air electrochemical cell generally includes an anode and a cathode in ionic communication via a separator and in fluid communication via one or more tubes or apertures, wherein the one or more tubes or apertures provide sufficient ionic resistance thereby preventing shorting between the electrodes while allowing liquid solvent to flow therebetween.

The above-discussed and other features and advantages of the present invention will be appreciated and understood by those skilled in the art from the following detailed description and drawings.

### BRIEF DESCRIPTION OF THE DRAWINGS

Numerous other advantages and features of the present invention will become readily apparent from the following detailed description of preferred embodiments when read in conjunction with the accompanying drawings, wherein:

FIG. 1 is a schematic representation of a conventional electrochemical cell having a bifunctional cathode;

FIG. 2 is a schematic representation of a conventional electrochemical cell having a monofunctional cathode and a charging electrode;

FIG. 3 is a schematic representation of an electrochemical cell including the electrolyte balance described herein and having a bifunctional cathode;

FIG. 4 is a schematic representation of an electrochemical cell including the electrolyte balance described herein and having a monofunctional cathode and a charging electrode; and

FIG. 5 is an alternative example of an electrolyte balance system detailed herein.

### DETAILED DESCRIPTION OF THE ILLUSTRATIVE EMBODIMENTS

A rechargeable metal air electrochemical cell is provided. The rechargeable metal air electrochemical cell includes a metal fuel anode, and air cathode, a recharging electrode (which may be a third electrode or a bifunctional air cathode), and a separator in ionic communication with the anode and cathode. Further, an electrolyte balance system is provided between the anode and the cathode, for example, in the form of a tube or one or more apertures, having suitable dimensions and configurations to minimize or prevent shorting between the cathode and anode.

Referring now to the drawings, an illustrative embodiment of the present invention will be described. For clarity of the description, like features shown in the figures shall be indicated with like reference numerals and similar features as shown in alternative embodiments shall be indicated with similar reference numerals.

Referring now to FIGS. 3, a rechargeable metal air electrochemical cell 300 is schematically depicted. Cell 300 includes an anode 312, a cathode 314 and a separator 316. The cell is immersed in an electrolyte bath 318 contained in a housing 320, or otherwise contains electrolyte (e.g., through suitable framing structures). Additionally, an electrolyte balance tube 330 is provided to allow for liquid or solvent communication between the anode 312 and the electrolyte bath 318.

Accordingly, the electrolyte balance tube 330 may provide sufficient liquid leveling in the cell 300 while greatly reducing the ionic conductivity through the electrolyte balance tube 330. This is particularly useful in systems wherein the separator or membrane provides sufficient conductivity for ion transferring but very limited conductivity for neutral species, such as water, to transfer. In one embodiment, tube 330 is thin and long tube as the only physical opening allowing liquid transfer between the electrodes (via the electrolyte), thus providing suitable dimensions and configurations to minimize or prevent shorting between the cathode and anode. The tube can also be curled to provide suitable dimensions and configurations to minimize or prevent shorting between the cathode and anode. Electrolyte can still flow through the tube because of hydraulic pressure difference. However, due to the dimensions and configurations of the tube, the ionic resistance can be sufficiently high to prevent electrochemical reactions from occurring, hence shorting of the cell.

Accordingly, one application of the tube 330 is to provide electrolyte leveling while eliminating shorting. Such a tube is especially valuable in rechargeable batteries where both ion and neutral liquids, such as water, need to be transferred during an electrochemical reaction. For example, metal air rechargeable electrochemical cells, nickel-zinc rechargeable electrochemical cells (e.g., wherein the anode is zinc or zinc oxide, and cathode is nickel oxide, manganese dioxide, silver oxide, or cobalt oxide), or nickel-iron (e.g., wherein the anode is iron or cadmium, and the cathode is nickel oxide) all may benefit from the use of the tube 330.

While not wishing to be bound by theory, it is believed that the balance system herein is based on the fact that in most solutions, the concentration of one component (e.g., the solute) is much less than the concentration of the other (e.g., the solvent). When a certain amount of a solution such as a potassium hydroxide (KOH) water solution moves through the tube 330, only a relatively small amount of potassium or hydroxide ions moves with the water. This amount of ions is not significant as compared to the amount of water moved. Therefore the electrochemical reaction due to the ions conducted through the tube is negligible. However the liquid will always be balanced through the tube.

For the “stationary” solution inside the tube, the ionic resistance through a straight tube can be calculated as:

Rλγl/A,

wherein γ is the specific resistance of the solution, “l” is the length of the tube, and “A” is the cross-section area of the tube. Because of the shape of the tube, “1/A” can be easily made very high and therefore generate a very high ionic resistance. For example, 1/A may generally be greater than about 3, preferably greater than about 5. Accordingly, the resistance can be further increased when the tube is configured to increase the effective length, such as a curled shape.

Referring now to FIG. 4, another embodiment of an electrochemical cell including the electrolyte balance system is disclosed. A cell 400 includes an anode 412 in ionic communication with a charging electrode 415 via a separator 416, and in ionic communication with a cathode 414 via the separator 416, charging electrode 415 and a separator 417 between electrode 415 and cathode 414. Additionally, the cell 400 includes an electrolyte balance tube 430, which serves the purpose as described above with respect to FIG. 3.

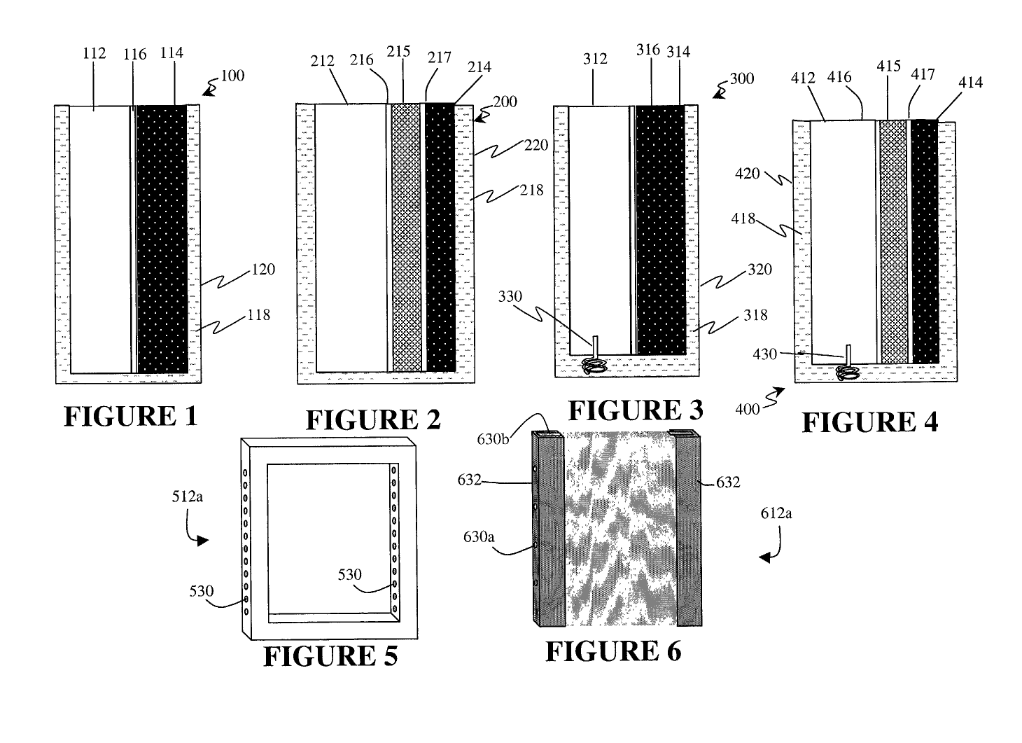

Note that while the electrolyte balance system is shown in FIGS. 3 and 4 as a curled tube, it is contemplated that one or more a straight tubes or one or more apertures may also be employed to provide a suitable 1/A ratio to minimize or prevent shorting between electrodes. That is, a plurality of apertures or tubes may be use to create a suitable dimension and configuration to minimize or prevent shorting between electrodes. For example, FIG. 5 shows an anode frame 512a, configured, for example, for use in a structure similar to the schematics of FIGS. 1 and 2. The anode frame 512a includes a plurality of holes 530 serving as the electrolyte balance system. The existence of sufficient holes, each of which has an 1/A value of generally at least 3, preferably at least 5, allows for sufficient electrolyte balance.

In the case of metal air cells, the anodes may generally comprise a metal constituent such as metal and/or metal oxides and a current collector. Optionally an ionic conducting medium is provided within the anode. Further, in certain embodiments, the anode comprises a binder and/or suitable additives. Preferably, the formulation optimizes ion conduction rate, capacity, density, and overall depth of discharge, while minimizing shape change during cycling.

The metal constituent may comprise mainly metals and metal compounds such as zinc, calcium, lithium, magnesium, ferrous metals, aluminum, oxides of at least one of the foregoing metals, or combinations and alloys comprising at least one of the foregoing metals. These metals may also be mixed or alloyed with constituents including, but not limited to, bismuth, calcium, magnesium, aluminum, indium, lead, mercury, gallium, tin, cadmium, germanium, antimony, selenium, thallium, oxides of at least one of the foregoing metals, or combinations comprising at least one of the foregoing constituents. The metal constituent may be provided in the form of powder, fibers, dust, granules, flakes, needles, pellets, or other particles. In certain embodiments, granule metal, particularly zinc alloy metal, is provided as the metal constituent. During conversion in the electrochemical process, the metal is generally converted to a metal oxide.

The anode current collector may be any electrically conductive material capable of providing electrical conductivity and optionally capable of providing support to the anode. The current collector may be formed of various electrically conductive materials including, but not limited to, copper, brass, ferrous metals such as stainless steel, nickel, carbon, electrically conducting polymer, electrically conducting ceramic, other electrically conducting materials that are stable in alkaline environments and do not corrode the electrode, or combinations and alloys comprising at least one of the foregoing materials. The current collector may be in the form of a mesh, porous plate, metal foam, strip, wire, plate, or other suitable structure.

The optional binder of the anode primarily maintains the constituents of the anode in a solid or substantially solid form in certain configurations. The binder may be any material that generally adheres the anode material and the current collector to form a suitable structure, and is generally provided in an amount suitable for adhesive purposes of the anode. This material is preferably chemically inert to the electrochemical environment. In certain embodiments, the binder material is soluble, or can form an emulsion, in water, and is not soluble in an electrolyte solution. Appropriate binder materials include polymers and copolymers based on polytetrafluoroethylene (e.g., Teflon® and Teflon® T-30 commercially available from E.I. du Pont Nemours and Company Corp., Wilmington, Del.), polyvinyl alcohol (PVA), poly(ethylene oxide) (PEO), polyvinylpyrrolidone (PVP), and the like, and derivatives, combinations and mixtures comprising at least one of the foregoing binder materials. However, one of skill in the art will recognize that other binder materials may be used.

Optional additives may be provided to prevent corrosion. Suitable additives include, but are not limited to indium oxide; zinc oxide, EDTA, surfactants such as sodium stearate, potassium Lauryl sulfate, Triton® X-400 (available from Union Carbide Chemical & Plastics Technology Corp., Danbury, Conn.), and other surfactants; the like; and derivatives, combinations and mixtures comprising at least one of the foregoing additive materials. However, one of skill in the art will determine that other additive materials may be used.

The electrolyte or ionic conducting medium generally comprises alkaline media to provide a path for hydroxyl to reach the metal and metal compounds. The ionically conducting medium may be in the form of a bath, wherein a liquid electrolyte solution is suitably contained. In certain embodiments, an ion conducting amount of electrolyte is provided in the anode. The electrolyte generally comprises ionic conducting materials such as KOH, NaOH, LiOH, other materials, or a combination comprising at least one of the foregoing electrolyte media. Particularly, the electrolyte may comprise aqueous electrolytes having a concentration of about 5% ionic conducting materials to about 55% ionic conducting materials, preferably about 10% ionic conducting materials to about 50% ionic conducting materials, and more preferably about 30% ionic conducting materials to about 45% ionic conducting materials. Other electrolytes may instead be used, however, depending on the capabilities thereof, as will be obvious to those of skill in the art.

The oxygen supplied to the cathode (in the case of metal air cells) may be from any oxygen source, such as air; scrubbed air; pure or substantially oxygen, such as from a utility or system supply or from on site oxygen manufacture; any other processed air; or any combination comprising at least one of the foregoing oxygen sources.

A cathode for a metal air cell may be a conventional air diffusion cathode, for example generally comprising an active constituent and a carbon substrate, along with suitable connecting structures, such as a current collector. Typically, the cathode catalyst is selected to attain current densities in ambient air of at least 20 milliamperes per squared centimeter (mA/cm²), preferably at least 50 mA/cm², and more preferably at least 100 mA/cm². Of course, higher current densities may be attained with suitable cathode catalysts and formulations. As described above, the cathode may be bi-functional, for example, which is capable of both operating during discharging and recharging.

The carbon used is preferably be chemically inert to the electrochemical cell environment and may be provided in various forms including, but not limited to, carbon flake, graphite, other high surface area carbon materials, or combinations comprising at least one of the foregoing carbon forms.

The cathode current collector may be any electrically conductive material capable of providing electrical conductivity and preferably chemically stable in alkaline solutions, which optionally is capable of providing support to the cathode. The current collector may be in the form of a mesh, porous plate, metal foam, strip, wire, plate, or other suitable structure. The current collector is generally porous to minimize oxygen flow obstruction. The current collector may be formed of various electrically conductive materials including, but not limited to, copper, ferrous metals such as stainless steel, nickel, chromium, titanium, and the like, and combinations and alloys comprising at least one of the foregoing materials. Suitable current collectors include porous metal such as nickel foam metal.

A binder is also typically used in the cathode, which may be any material that adheres substrate materials, the current collector, and the catalyst to form a suitable structure. The binder is generally provided in an amount suitable for adhesive purposes of the carbon, catalyst, and/or current collector. This material is preferably chemically inert to the electrochemical environment. In certain embodiments, the binder material also has hydrophobic characteristics. Appropriate binder materials include polymers and copolymers based on polytetrafluoroethylene (e.g., Teflon® and Teflon® T-30 commercially available from E.I. du Pont Nemours and Company Corp., Wilmington, Del.), polyvinyl alcohol (PVA), poly(ethylene oxide) (PEO), polyvinylpyrrolidone (PVP), and the like, and derivatives, combinations and mixtures comprising at least one of the foregoing binder materials. However, one of skill in the art will recognize that other binder materials may be used.

The active constituent is generally a suitable catalyst material to facilitate oxygen reaction at the cathode. The catalyst material is generally provided in an effective amount to facilitate oxygen reaction at the cathode. Suitable catalyst materials include, but are not limited to: manganese, lanthanum, strontium, cobalt, platinum, and combinations and oxides comprising at least one of the foregoing catalyst materials. An exemplary air cathode is disclosed in copending, commonly assigned U.S. patent application Ser. No. 09/415,449, entitled “Electrochemical Electrode For Fuel Cell”, to Wayne Yao and Tsepin Tsai, filed on Oct. 8, 1999, which is incorporated herein by reference in its entirety. Other air cathodes may instead be used, however, depending on the performance capabilities thereof, as will be obvious to those of skill in the art.

To electrically isolate the anode from the cathode, a separator is provided between the electrodes, as is known in the art. The separator may be any commercially available separator capable of electrically isolating the anode and the cathode, while allowing sufficient ionic transport therebetween. Preferably, the separator is flexible, to accommodate electrochemical expansion and contraction of the cell components, and chemically inert to the cell chemicals. Suitable separators are provided in forms including, but not limited to, woven, non-woven, porous (such as microporous or nanoporous), cellular, polymer sheets, and the like. Materials for the separator include, but are not limited to, polyolefin (e.g., Gelgard® commercially available from Dow Chemical Company), polyvinyl alcohol (PVA), cellulose (e.g., nitrocellulose, cellulose acetate, and the like), polyethylene, polyamide (e.g., nylon), fluorocarbon-type resins (e.g., the Nafion® family of resins which have sulfonic acid group functionality, commercially available from du Pont), cellophane, filter paper, and combinations comprising at least one of the foregoing materials. The separator may also comprise additives and/or coatings such as acrylic compounds and the like to make them more wettable and permeable to the electrolyte.

In certain embodiments, the separator comprises a membrane having electrolyte, such as hydroxide conducting electrolytes, incorporated therein. Such membranes may be capable of allowing sufficient ionic conductivity, however have low permeability to water, thus preventing solvent transport. The membrane may have hydroxide conducing properties by virtue of: physical characteristics (e.g., porosity) capable of supporting a hydroxide source, such as a gelatinous alkaline material; molecular structure that supports a hydroxide source, such as an aqueous electrolyte; anion exchange properties, such as anion exchange membranes; or a combination of one or more of these characteristics capable of providing the hydroxide source.

For instance, the separator may comprise a material having physical characteristics (e.g., porosity) capable of supporting a hydroxide source, such as a gelatinous alkaline solution. For example, various separators capable of providing ionically conducting media are described in: U.S. Pat. No. 5,250,370 entitled “Variable Area Dynamic Battery,” Sadeg M. Faris, Issued Oct. 5, 1993; U.S. application Ser. No. 08/944,507 filed Oct. 6, 1997 entitled “System and Method for Producing Electrical Power Using Metal Air Fuel Cell Battery Technology,” Sadeg M. Faris, Yuen-Ming Chang, Tsepin Tsai, and Wayne Yao; U.S. Application Ser. No. 09/074,337 filed May 7, 1998 entitled “Metal-Air Fuel Cell Battery Systems,” Sadeg M. Faris and Tsepin Tsai; U.S. Application Ser. No. 09/110,762 filed Jul. 3, 1998 entitled “Metal-Air Fuel Cell Battery System Employing Metal Fuel Tape and Low-Friction Cathode Structures,” Sadeg M. Faris, Tsepin Tsai, Thomas J. Legbandt, Muguo Chen, and Wayne Yao; U.S. Pat. No. 6,190,792 issued Feb. 20, 2001 entitled “Ionically-Conductive Belt Structure for Use in a Metal-Air Fuel Cell Battery System and Method of Fabricating the Same,” Sadeg M. Faris, Tsepin Tsai, Thomas Legbandt, Wenbin Yao, and Muguo Chen; U.S. Application Ser. No. 09/116,643 filed Jul. 16, 1998 entitled “Metal-Air Fuel Cell Battery System Employing Means for Discharging and Recharging Metal-Fuel Cards,” Sadeg M. Faris, Tsepin Tsai, Wenbin Yao, and Muguo Chen; U.S. application Ser. No. 09/268,150 filed Mar. 15, 1999 entitled “Movable Anode Fuel Cell Battery,” by Tsepin Tsai and William Morris; U.S. application Ser. No. 09/526,669 filed Mar. 15, 2000 “Movable Anode Fuel Cell Battery,” Tsepin Tsai, William F. Morris, all of which are herein incorporated by reference.

In general, the type of material having physical characteristics capable of supporting a hydroxide source may comprise an electrolyte gel. The electrolyte gel may be either applied directly on the surface of the evolution and/or reduction electrodes, or applied as a self supported membrane between the evolution and reduction electrodes. Alternatively, the gel may be supported by a substrate and incorporated between the evolution and reduction electrodes.

The electrolyte (either within any one of the variations of the separator herein, or as a liquid within the cell structure in general) generally comprises ion conducting material to allow ionic conduction between the metal anode and the cathode. The electrolyte generally comprises hydroxide-conducting materials such as KOH, NaOH, LiOH, RbOH, CsOH or a combination comprising at least one of the foregoing electrolyte media. In preferred embodiments, the hydroxide-conducting material comprises KOH. Particularly, the electrolyte may comprise aqueous electrolytes having a concentration of about 5% ionic conducting materials to about 55% ionic conducting materials, preferably about 10% ionic conducting materials to about 50% ionic conducting materials, and more preferably about 30% ionic conducting materials to about 40% ionic conducting materials.

The gelling agent for the membrane may be any suitable gelling agent in sufficient quantity to provide the desired consistency of the material. The gelling agent may be a crosslinked polyacrylic acid (PAA), such as the Carbopol® family of crosslinked polyacrylic acids (e.g., Carbopol® 675) available from BF Goodrich Company, Charlotte, N.C., Alcosorb® GI commercially available from Allied Colloids Limited (West Yorkshire, GB), and potassium and sodium salts of polyacrylic acid; carboxymethyl cellulose (CMC), such as those available from Aldrich Chemical Co., Inc., Milwaukee, Wisc.; hydroxypropylmethyl cellulose; gelatine; polyvinyl alcohol (PVA); poly(ethylene oxide) (PEO); polybutylvinyl alcohol (PBVA); combinations comprising at least one of the foregoing gelling agents; and the like. Generally, the gelling agent concentration is from about 0.1% to about 50% preferably about 2% to about 10%.

The optional substrate may be provided in forms including, but not limited to, woven, non-woven, porous (such as microporous or nanoporous), cellular, polymer sheets, and the like, which are capable of allowing sufficient ionic transport between the reduction and evolution electrodes. In certain embodiments, the substrate is flexible, to accommodate electrochemical expansion and contraction of the cell components, and chemically inert to the cell materials. Materials for the substrate include, but are not limited to, polyolefin (e.g., Gelgard® commercially available from Daramic Inc., Burlington, Mass.), polyvinyl alcohol (PVA), cellulose (e.g., nitrocellulose, cellulose acetate, and the like), polyamide (e.g., nylon), cellophane, filter paper, and combinations comprising at least one of the foregoing materials. The substrate may also comprise additives and/or coatings such as acrylic compounds and the like to make them more wettable and permeable to the electrolyte.

In other embodiments of a hydroxide-conducting membrane as a separator, a molecular structure is provided that supports a hydroxide source, such as an aqueous electrolyte. Such membranes are desirable in that conductivity benefits of aqueous electrolytes may be achieved in a self supported solid state structure. In certain embodiments, the membrane may be fabricated from a composite of a polymeric material and an electrolyte. The molecular structure of the polymeric material supports the electrolyte. Cross-linking and/or polymeric strands serve to maintain the electrolyte.

In one example of a conductive separator, a polymeric material such as polyvinyl chloride (PVC) or poly(ethylene oxide) (PEO) is formed integrally with a hydroxide source as a thick film. In a first formulation, one mole of KOH and 0.1 mole of calcium chloride are dissolved in a mixed solution of 60 milliliters of water and 40 milliliters of tetrahydrogen furan (TKF). Calcium chloride is provided as a hygroscopic agent. Thereafter, one mole of PEO is added to the mixture. In a second formulation, the same materials for the first formula are used, with the substitution of PVC for PEO. The solution is cast (or coated) as a thick film onto substrate, such as polyvinyl alcohol (PVA) type plastic material. Other substrate materials preferably having a surface tension higher than the film material may be used. As the mixed solvents evaporate from the applied coating, an ionically-conductive solid state membrane (i.e. thick film) is formed on the PVA substrate. By peeling the solid state membrane off the PVA substrate, a solid-state ionically-conductive membrane or film is formed. Using the above formulations, it is possible to form ionically-conductive films having a thickness in the range of about 0.2 to about 0.5 millimeters.

Other embodiments of conductive membranes suitable as a separator are described in greater detail in: U.S. patent application Ser. No. 09/259,068, entitled “Solid Gel Membrane”, by Muguo Chen, Tsepin Tsai, Wayne Yao, Yuen-Ming Chang, Lin-Feng Li, and Tom Karen, filed on Feb. 26, 1999; U.S. patent application Ser. No. 09/482,126 entitled “Solid Gel Membrane Separator in Rechargeable Electrochemical Cells”, by Tsepin Tsai, Muguo Chen and Lin-Feng Li, filed Jan. 11, 2000; U.S. Ser. No. 09/943,053 entitled “Polymer Matrix Material”, by Robert Callahan, Mark Stevens and Muguo Chen, filed on Aug. 30, 2001; and U.S. Ser. No. 09/942,887 entitled “Electrochemical Cell Incorporating Polymer Matrix Material”, by Robert Callahan, Mark Stevens and Muguo Chen, filed on Aug. 30, 2001; all of which are incorporated by reference herein in their entireties.

In certain embodiments, the polymeric material used as separator comprises a polymerization product of one or more monomers selected from the group of water soluble ethylenically unsaturated amides and acids, and optionally a water soluble or water swellable polymer. The polymerized product may be formed on a support material or substrate. The support material or substrate may be, but not limited to, a woven or nonwoven fabric, such as a polyolefin, polyvinyl alcohol, cellulose, or a polyamide, such as nylon.

The electrolyte may be added prior to polymerization of the above monomer(s), or after polymerization. For example, in one embodiment, electrolyte may be added to a solution containing the monomer(s), an optional polymerization initiator, and an optional reinforcing element prior to polymerization, and it remains embedded in the polymeric material after the polymerization. Alternatively, the polymerization may be effectuated without the electrolyte, wherein the electrolyte is subsequently included.

The water soluble ethylenically unsaturated amide and acid monomers may include methylenebisacrylamide, acrylamide, methacrylic acid, acrylic acid, 1-vinyl-2-pyrrolidinone, N-isopropylacrylamide, fumaramide, fumaric acid, N,N-dimethylacrylamide, 3,3-dimethylacrylic acid, and the sodium salt of vinylsulfonic acid, other water soluble ethylenically unsaturated amide and acid monomers, or combinations comprising at least one of the foregoing monomers.

The water soluble or water swellable polymer, which acts as a reinforcing element, may include polysulfone (anionic), poly(sodium 4-styrenesulfonate), carboxymethyl cellulose, sodium salt of poly(styrenesulfonic acid-co-maleic acid), corn starch, any other water-soluble or water-swellable polymers, or combinations comprising at least one of the foregoing water soluble or water swellable polymers. The addition of the reinforcing element enhances mechanical strength of the polymer structure.

Optionally, a crosslinking agent may be used, such as methylenebisacrylamide, ethylenebisacrylamide, any water-soluble N,N′-alkylidene-bis(ethylenically unsaturated amide), other crosslinkers, or combinations comprising at least one of the foregoing crosslinking agents.

A polymerization initiator may also be included, such as ammonium persulfate, alkali metal persulfates and peroxides, other initiators, or combinations comprising at least one of the foregoing initiators. Further, an initiator may be used in combination with radical generating methods such as radiation, including for example, ultraviolet light, X-ray, γ-ray, and the like. However, the chemical initiators need not be added if the radiation alone is sufficiently powerful to begin the polymerization.

In one method of forming the polymeric material, the selected fabric may be soaked in the monomer solution (with or without the ionic species), the solution-coated fabric is cooled, and a polymerization initiator is optionally added. The monomer solution may be polymerized by heating, irradiating with ultraviolet light, gamma-rays, x-rays, electron beam, or a combination thereof, wherein the polymeric material is produced. When the ionic species is included in the polymerized solution, the hydroxide ion (or other ions) remains in solution after the polymerization. Further, when the polymeric material does not include the ionic species, it may be added by, for example, soaking the polymeric material in an ionic solution.

Polymerization is generally carried out at a temperature ranging from room temperature to about 130° C., but preferably at an elevated temperature ranging from about 75° to about 100° C. Optionally, the polymerization may be carried out using radiation in conjunction with heating. Alternatively, the polymerization may be performed using radiation alone without raising the temperature of the ingredients, depending on the strength of the radiation. Examples of radiation types useful in the polymerization reaction include, but are not limited to, ultraviolet light, gamma-rays, x-rays, electron beam, or a combination thereof.

To control the thickness of the membrane, the coated fabric may be placed in suitable molds prior to polymerization. Alternatively, the fabric coated with the monomer solution may be placed between suitable films such as glass and polyethylene teraphthalate (PET) film. The thickness of the film may be varied will be obvious to those of skill in the art based on its effectiveness in a particular application. In certain embodiments, for example for separating oxygen from air, the membrane or separator may have a thickness of about 0.1 mm to about 0.6 mm. Because the actual conducting media remains in aqueous solution within the polymer backbone, the conductivity of the membrane is comparable to that of liquid electrolytes, which at room temperature is significantly high. In still further embodiments of the separator, anion exchange membranes are employed. Some exemplary anion exchange membranes are based on organic polymers comprising a quaternary ammonium salt structure functionality; strong base polystyrene divinylbenzene cross-linked Type I anion exchangers; weak base polystyrene divinylbenzene cross-linked anion exchangers; strong base/weak base polystyrene divinylbenzene cross-linked Type II anion exchangers; strong base/weak base acrylic anion exchangers; strong base perfluoro aminated anion exchangers; naturally occurring anion exchangers such as certain clays; and combinations and blends comprising at least one of the foregoing materials. An exemplary anion exchange material is described in greater detail in U.S. Provisional Patent Application No. 60/307,312 entitled “Anion Exchange Material”, by Muguo Chen and Robert Callahan, filed on Jul. 23, 2001, and incorporated by reference herein.

Another example of a suitable anion exchange membrane is described in greater detail in U.S. Pat. No. 6,183,914 and incorporated by reference herein. The membrane includes an ammonium-based polymer comprising (a) an organic polymer having an alkyl quaternary ammonium salt structure; (b) a nitrogen-containing, heterocyclic ammonium salt; and (c) a source of hydroxide anion.

In yet another embodiment, mechanical strength of the resulting membrane may be increased by casting the composition on a support material or substrate, which is preferably a woven or nonwoven fabric, such as a polyolefin, polyester, polyvinyl alcohol, cellulose, or a polyamide, such as nylon.

The charging electrode may comprise an electrically conducting structure, for example a mesh, porous plate, metal foam, strip, wire, plate, or other suitable structure. In certain embodiments, the charging electrode is porous to allow ionic transfer. The charging electrode may be formed of various electrically conductive materials including, but not limited to, copper, ferrous metals such as stainless steel, nickel, chromium, titanium, and the like, and combinations and alloys comprising at least one of the foregoing materials. Suitable charging electrodes include porous metal such as nickel foam metal.

While preferred embodiments have been shown and described, various modifications and substitutions may be made thereto without departing from the spirit and scope of the invention. Accordingly, it is to be understood that the present invention has been described by way of illustrations and not limitation.

What is claimed is:

1. A rechargeable electrochemical cell comprising:
an anode and a cathode in ionic communication via a separator and in fluid communication via one or more tubes or apertures, wherein the one or more tubes or apertures provide sufficient ionic resistance thereby preventing shorting between the electrodes while allowing liquid solvent to flow therebetween.

2. The rechargeable electrochemical cell as in claim 1, wherein the anode is metal and the cathode is an air diffusion cathode.

3. A nickel-zinc rechargeable electrochemical cell as in claim 1.

4. A nickel-iron rechargeable electrochemical cell as in claim 1.

5. The rechargeable electrochemical cell as in claim 1, further comprising a charging electrode positioned between the anode and the cathode.
